(19) United States
(12) Patent Application Publication
(10) Pub. No.: US 2020/0215638 A1
(43) Pub. Date: Jul. 9, 2020

(54) TIG TORCH FOR WELDING, SOLDERING OR COATING

(71) Applicant: KJELLBERG-STIFTUNG, Finsterwalde (DE)

(72) Inventors: Henning SCHUSTER, Dresden (DE); Michael DREHER, Dresden (DE); Michael SCHNICK, Oberlungwitz (DE)

(73) Assignee: KJELLBERG-STIFTUNG, Finsterwalde (DE)

(21) Appl. No.: 16/647,650

(22) PCT Filed: Sep. 12, 2018
(86) PCT No.: PCT/EP2018/074590

§ 371 Date: Mar. 16, 2020

(30) Foreign Application Priority Data
Sep. 15, 2017 (DE) 10 2017 216 440.9

(51) Int. Cl. B23K 9/167; B23K 9/16; B23K 9/29; B23K 37/00; B23K 9/32; B23K 35/02

(52) U.S. Cl. CPC B23K 9/167; B23K 9/164; B23K 9/296; B23K 35/0272; B23K 9/325; B23K 37/006; B23K 37/003

(57) ABSTRACT

A TIG torch for welding, soldering or coating, wherein an electrode is radially surrounded by an inner gas nozzle as far as the electrode tip. A first gas flow in the direction of a workpiece surface through a gap between the inner lateral surface of the inner gas nozzle and the lateral surface of the electrode. The inner gas nozzle is fastened to a sleeve-shaped inner gas nozzle carrier and is surrounded by an outer gas nozzle fixed to an outer gas nozzle carrier or an outer gas nozzle. A second gas flow in the direction of the workpiece surface between the radially outer lateral surface of the inner gas nozzle and the inner lateral surface of the outer gas nozzle. An electrically insulating element is arranged between the inner gas nozzle carrier, inner gas nozzle and/or electrode and the outer gas nozzle carrier and/or outer gas nozzle.

### BACKGROUND OF THE INVENTION

The invention relates to a TIG torch which can be used for welding, soldering and coating.

During ignition or during operation, TIG torches with an additional (inner) gas nozzle between a non-consumable electrode and an outer gas nozzle are subject to the risk of electrical short circuits occurring or secondary arcs becoming established between the electrode and the inner gas nozzle and/or between at least one of the two gas nozzles and the workpiece. In addition to damage to the workpiece or to the weld seam (rejection or reworking), said electrical short circuits or secondary arcs also generally lead to considerable damage to the nozzles and sometimes even to destruction of the torch.

This problem can be exacerbated by incorrect orientation, that is to say asymmetrical arrangement of elements of a torch of this kind in the region of electrically conductive and operating elements, in particular on the electrode, an electrode holder or other electrically conductive elements and elements which are electrically conductively connected to the electrode. Secondly, additional secondary arcs can be ignited or electrical short circuits can be triggered when the respective TIG torch butts against a workpiece or an object which is arranged in the area surrounding said workpiece during processing.

In particular, owing to the two gas streams which are to be guided separately from one another, problems in terms of thermodynamics and flow can also occur during operation of a torch of this kind, in particular owing to thermodynamic problems or non-optimal gas guidance.

### SUMMARY OF THE INVENTION

The object of the invention is therefore to specify possible ways of increasing the operational reliability of TIG torches.

According to the invention, this object is achieved by a TIG torch which has the features of the independent claim and refinements and developments of the invention can be implemented with features which are identified in the dependent claims.

In the TIG torch according to the invention, an electrode is radially surrounded by an inner gas nozzle. In this case, at least the electrode tip protrudes beyond all parts of the TIG torch in the direction of the workpiece surface. A first gas stream is guided in the direction of a workpiece surface through at least one gap between the inner lateral surface of the inner gas nozzle and the outer lateral surface of the electrode. The inner gas nozzle is fastened to a sleeve-like inner gas nozzle carrier or directly to an electrically insulating element. The inner gas nozzle should be radially surrounded at least as far as the electrode tip (6) which protrudes out of the TIG torch.

The inner gas nozzle is also surrounded in the radial direction by an outer gas nozzle which is fastened to an outer gas nozzle carrier as an alternative. A second gas stream is guided in the direction of the workpiece surface between the radially outer lateral surface of the inner gas nozzle and the inner lateral surface of the outer gas nozzle. The second gas stream flows around the first first gas stream, which flows out of the inner gas nozzle, on its outer side over the entire circumference.

An electrically insulating element is arranged between the inner gas nozzle carrier, the inner gas nozzle and/or the electrode and the outer gas nozzle carrier and/or the outer gas nozzle, said electrically insulating element being able to prevent electrical short circuits or the formation of secondary arcs in this region. In another alternative, the inner gas nozzle is directly connected to the electrically insulating element.

The electrically insulating element is particularly advantageously of sleeve-like design.

Said electrically insulating element should be connected in a rotationally fixed and rotationally symmetrical manner to the outer gas nozzle carrier and to the inner gas nozzle carrier in a manner oriented with respect to the central longitudinal axis of the electrode. Possible ways of achieving this objective are intended to be discussed in more detail later.

Grooves, ducts and/or bores for guiding the first gas stream, the second gas stream and/or a cooling medium can advantageously be formed in the and/or on the sleeve-like electrically insulating element. To this end, grooves or ducts can be formed within the electrically insulating element, but also on the surface of said electrically insulating element. Bores can be guided through the material of the electrically insulating element as far as a groove or a duct for the purpose of supplying or discharging gas or cooling medium.

In this case, grooves or ducts can be oriented in parallel or at an obliquely inclined angle which is not equal to 90°, so that gas or cooling medium can flow through the electrically insulating element in the direction of the longitudinal axis of the TIG torch or of the electrode.

A gas or cooling medium can likewise be guided to a specific position for inflow or outflow or else for cooling purposes by way of grooves or bores which are oriented perpendicularly in relation to the longitudinal axis of the TIG torch or of the electrode and which are formed on an outer surface of the electrically insulating element.

In an advantageous embodiment, a measuring device for monitoring an electric current flow or the electrical voltage potential of the inner gas nozzle and/or the outer gas nozzle can be arranged or connected between the electrode and the inner gas nozzle and/or the inner gas nozzle and the outer gas nozzle, and can be connected to an evaluation and/or switch-off unit for the arc on the TIG torch. In this way, electrical short circuits or the formation of an undesired secondary arc can be identified and undesired damage can be prevented by promptly interrupting the main arc between the electrode tip and the workpiece, that is to say completely switching off the TIG torch. An electrical resistor should preferably be interposed when measuring an electric current or an electrical voltage potential.

An electrode can be formed with an electrode tip which is fastened to an electrode holder. The electrode holder can be connected to an electrode cooling tube or the electrode cooling tube can merge with the electrode holder. In this case, an electrode cooling tube is arranged on that side of the electrode holder which is situated opposite the electrode tip. Said electrode cooling tube should be of hollow design on the inside for the purpose of guiding a cooling medium at least up to close to the electrode tip.

A gas distributor which homogenizes the second gas stream in the form of a ring can also advantageously be arranged on the end side of the sleeve-like electrically insulating element, which end side faces in the direction of the workpiece surface. The second gas stream can be guided to this gas distributor by way of ducts, bores or grooves which are present on the electrically insulating element. Said electrically insulating element has a build-up effect there, this in turn advantageously influencing the desired homogenization of the second gas stream exiting the gas distributor.

The gas distributor can be designed in the form of a screen, as an open-pore sintered body, as an open-pore foam body, with bores which are arranged in a manner distributed at equal distances from one another and have a small free cross section, or in the form of a perforated metal sheet and is connected to a supply for the second gas stream through the sleeve-like electrically insulating element.

The gas distributor should be connected in a gas-tight manner, preferably by means of a press-fit connection, to the electrically insulating element on its outer lateral surfaces as far as the supply for the second gas stream.

At least one further electrically insulating element can be arranged in the gap between the outer lateral surface of the electrode and the inner lateral surface of the inner gas nozzle. The further electrically insulating element can likewise be designed in a sleeve-like manner. However, in this case, it should be dimensioned such that a free gap is left for the free passage of the first gas stream.

However, an electrically insulating coating can also be formed on the outer lateral surface of the electrode and/or on the inner lateral surface of the inner gas nozzle in a locally defined manner, so that the first gas stream can flow in the direction of the workpiece surface and at the same time an electrical short circuit between the electrode and the inner gas nozzle can be prevented. As a result, concentric orientation of the electrode holder and the inner gas nozzle can be complied with while maintaining a constant gap size between the outer lateral surface of the electrode holder and the inner lateral surface of the inner gas nozzle over the entire circumference, so that constant flow conditions of the first gas stream can be achieved over the entire circumference.

An electrically insulating coating can be connected in a cohesive manner on surfaces of the electrode and/or of the inner gas nozzle in a locally defined manner. A polymer can form coatings of this kind. Electrically insulating coatings can also have been formed by thermally spraying a ceramic material.

A plurality of further electrically insulating elements which are arranged in a manner distributed at a distance from one another over the outer circumference of the electrode can also be provided. In this case, the first gas stream can flow through between the further electrically insulating elements. A plurality of further electrically insulating elements which are arranged and designed in this way can be arranged as spacers between the outer lateral surface of the electrode and the inner lateral surface of the inner gas nozzle and can bear against the respective lateral surfaces of the electrode and of the inner gas nozzle which face one another.

The electrically insulating element can be fastened in a cohesive, interlocking and/or force-fitting manner in the form of a rotation-prevention means to the electrode, to an electrode tube or electrode holder which secures the electrode and/or to the outer gas nozzle carrier.

To this end, the outer and/or the inner lateral surface of the electrically insulating element can be rotationally fixedly secured in a non-rotationally symmetrical, preferably polygonal, manner as a key/slot connection, with a toothing or by means of an element which engages in an interlocking manner, in particular a screw or a pin.

A spline toothing can advantageously be formed with a on the lateral surface of the inner gas nozzle carrier. In this case, the spline toothing can be connected in an interlocking manner to the inner lateral surface of the electrically insulating element by being pressed in in a direction parallel to the longitudinal axis of the TIG torch.

An electrode holder, an inner gas nozzle, an inner gas nozzle carrier, an outer gas nozzle or an outer gas nozzle carrier can each be formed in one piece, but also can each be formed from a plurality of individual elements which are connected to one another.

The electrically insulating element can be formed from a ceramic, polymeric material, a polymer or ceramic fiber composite material or a metal-ceramic or metal-polymer composite material. In the case of a composite, the regions which are formed from metal should be arranged such that there is no electrically conductive connection between the inner gas nozzle carrier, the inner gas nozzle and/or the electrode and the outer gas nozzle carrier and/or the outer gas nozzle. Suitable polymers which can be used are, for example, polyamideimide, PEEK or polyimide.

The outer gas nozzle can be connected to the outer gas nozzle carrier and the inner gas nozzle can be connected to the inner gas nozzle carrier by means of screw connection.

The abovementioned bores through which gas or cooling medium can flow can also be designed as blind hole bores. Bores can also be provided or closed with valves, screws with sealing. Grooves can be designed in a radially partially or completely encircling manner. For example, said grooves can be designed as annular grooves.

The problem can be solved by the invention and in particular by the electrically insulating element. The electrically insulating element can electrically insulate an electrode tube (electrode holder or carrier of the electrode) and also the metal receptacles of the outer and the inner gas nozzle comprising the outer gas nozzle carrier and the inner gas nozzle carrier from one another and prevent electrical short circuits and also undesired secondary arcs. Bores, connection bores or connection posts and encircling grooves can be provided, so that both one or more gases (independent gas supplies, gas bores) are guided and/or the circuit for a cooling medium between an electrode cooling system and a heat exchanger can be closed by the electrically insulating element. The latter may be necessary and achievable for cooling at least one of the two nozzle carriers.

According to the invention, a torch main body, which in addition to holding the electrodes and nozzle holders in a potential-isolated manner, can also fulfil at least one further function of complex gas guidance or cooling medium guidance (line, distribution etc.), is provided with a simple electrically insulating element.

### DESCRIPTION OF THE DRAWINGS

The invention is intended to be explained in more detail in the text which follows by way of example. Here, individual features, shown in the figures, can be combined with one another independently of the respective example or the respective figure.

In the drawings:

FIG. 1 shows a sectional illustration through an example of a TIG torch according to the invention;

FIG. 2 shows a perspective sectional illustration of an example of an electrically insulating element which can be used in a TIG torch according to the invention and which is arranged on an electrode tube and between an inner gas nozzle carrier and an outer gas nozzle carrier;

FIG. 3 shows a perspective illustration of an example of an electrically insulating element which can be used in the invention;

FIG. 4 shows a first sectional illustration through the example shown in FIG. 3;

FIG. 5 shows a second sectional illustration through the example shown in FIG. 3;

FIG. 6 shows a third sectional illustration through the example shown in FIG. 3;

FIG. 7 shows a sectional illustration of an example of an electrically insulating element;

FIG. 8 shows a sectional illustration of an example in which grooves are formed in an inner lateral surface of an outer gas nozzle;

FIG. 9 shows a sectional illustration of an example in which grooves are formed in an outer lateral surface of an electrode holder and/or electrode tube;

FIG. 10 shows a sectional illustration of an example in which grooves are formed in an inner lateral surface of an outer gas nozzle and in an outer lateral surface of an electrode holder and/or electrode tube, and

FIG. 11 shows a sectional illustration of an example in which the ducts are formed through or in an electrically insulating element.

### DETAILED DESCRIPTION OF THE INVENTION

FIG. 1 shows a sectional illustration of an example of a TIG torch according to the invention. The illustration of supplies for gases, a cooling medium, a heat exchanger for cooling and other elements which are actually required for operation has been omitted from said figure. Only the elements which are essential for implementing the invention are shown.

An electrode tube 10, which is of hollow design on the inside for cooling purposes, is arranged centrally in the longitudinal axis of the TIG torch. A cooling medium is guided in the hollow space as far as the region at which an electrode holder 5 is formed and the electrode tip (6), which is composed of tungsten, is fastened. The electrode tube 10, comprising an electrode holder 5 which is formed on that side of said electrode tube which faces in the direction of a workpiece surface to be processed, is connected to the positive pole of an electrical power supply unit. However, said electrode tube could also be connected to the negative pole.

The electrode tube (10) is connected in a rotationally fixed manner to the electrically insulating element 1 by means of a polygonal connection. The inner gas nozzle carrier 3 is likewise connected in a rotationally fixed manner to the electrically insulating element 1 by means of a press-fit toothing.

The inner gas nozzle 8 can likewise be fastened to the outer lateral surface of the inner gas nozzle carrier 3 by means of screw connection. An annular gap through which a first gas stream can flow out of the TIG torch in the direction of the workpiece surface is formed between the electrode tube 10 and the inner gas nozzle 8 between that region of the TIG torch which faces in the direction of the workpiece surface.

The electrically insulating element 1 in the form of a sleeve is arranged and fastened in a rotationally fixed manner between the outer lateral surface of the inner gas nozzle carrier 3, possibly the electrode holder 5, the electrode tube 10 and the outer gas nozzle carrier 2, which is likewise of sleeve-like design, as has already been explained in the general part of the description. However, the electrically insulating element can also be rigidly fastened to the TIG torch or to the torch housing and additionally can be attached in a rotationally fixed manner to the electrode tube 10, to the inner gas nozzle carrier 3 and also to the outer gas nozzle carrier 2.

The outer gas nozzle 7 is screwed onto the outer gas nozzle carrier 2, so that there is an annular gap between the inner gas nozzle 8 and the outer gas nozzle 7, it being possible for a second gas stream to flow through said annular gap in the direction of a workpiece surface to be processed.

The inner gas nozzle 8, the outer gas nozzle 7 and the electrode holder 5 comprising the electrode tube 10 are dimensioned and connected to one another such that the electrode tip 6 is arranged outside, that is to say in front of the outer end faces of, the inner gas nozzle 8 and the outer gas nozzle 7 in the direction of the workpiece surface.

A sealing ring 9 which is secured in a groove and with which passage of gas and/or cooling medium can be prevented is arranged between the inner lateral surface of the outer gas nozzle carrier 2 and the outer lateral surface of the electrically insulating element 1.

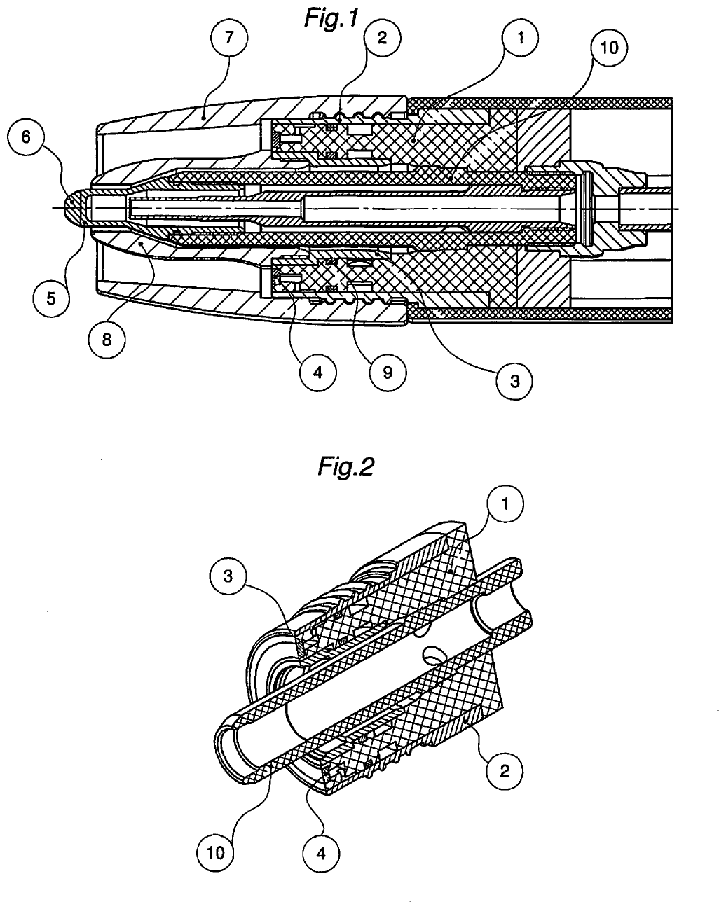

It is clear from the illustration in FIG. 2 that there is a gas distributor 4 on that end side of the electrically insulating element 1 which is arranged in the direction of the workpiece surface to be processed, it being possible for the second gas stream to be guided through said gas distributor. An annular channel in the form of a radially encircling groove is formed on the electrically insulating element 1 behind the gas distributor 4, it being possible for the second gas stream to enter said radially encircling groove through further grooves and ducts. In this example, the gas distributor 4 is designed as an open-pore sintered body composed of ceramic material. Said gas distributor is dimensioned and designed with pore sizes and porosities such that the second gas stream can exit homogenously over the entire exit area of the gas distributor 4 and in so doing the second gas stream which exits in the form of a ring has the same axial speed and the same volume flow at each point. Before the second gas stream enters the gas distributor, this gas has a greater pressure owing to the back-pressure effect of the gas distributor 4.

The gas distributor (4) is fastened to the electrically insulating element 1 by means of press fits. As a result, the gas distributor 4 can be securely held on the electrically insulating element 1 and leakage currents the second gas streams past the gas distributor 4 can be prevented.

The electrically insulating element 1 can be produced as an injection-molded part or by mechanical processing. Given a ceramic material, production can also be achieved by sintering in a suitable mold, in particular by hot isostatic pressing.

FIG. 2 also shows how the electrode tube 10 can be connected in a rotationally fixed manner to the inner gas nozzle carrier 3 by means of polygonal and spline toothing.

Similarly to the inner gas nozzle carrier 3, the outer gas nozzle carrier 2 can be fastened on the outer lateral surface of the electrically insulating element 1.

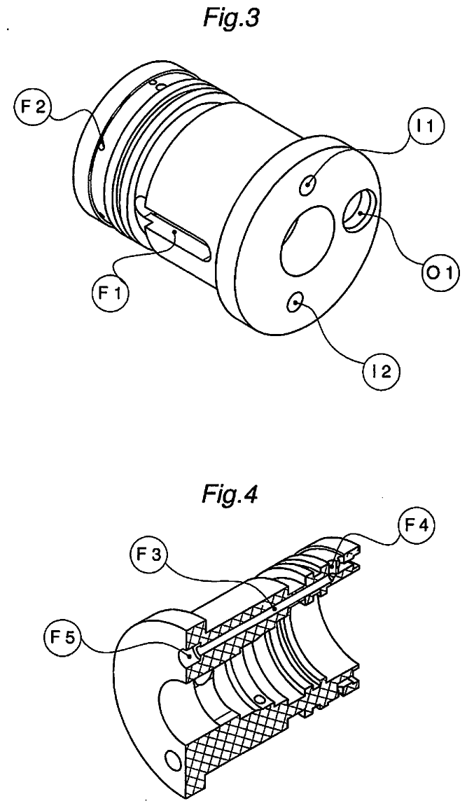

FIG. 3 shows a perspective illustration of an electrically insulating element 1, in which two bores 11 for the first gas stream and 12 for the second gas stream are formed on an end side, it being possible for the two gas streams to flow into the electrically insulating element 1 through said bores. A third bore O1, through which a cooling medium can flow out into the electrically insulating element 1, is additionally formed there. The cooling medium can flow through the duct F1 for the purpose of cooling the outer gas nozzle carrier 2 and the inner gas nozzle carrier 3.

In the example shown here, bores F2 with a very small inside diameter are formed in a manner distributed uniformly over the circumference on the opposite end side of the electrically insulating element 1, it being possible for said bores to fulfil the function of the gas distributor 4. The second gas stream can flow out through at least one duct, not shown here, starting from the bore I1, into an annular channel, which is formed in the interior of the electrically insulating element 1, in the form of an annular groove and out of this annular groove through the bores F2 in the direction of the workpiece to be processed.

The second gas stream can flow out of the bore F4 parallel to the longitudinal axis of the TIG torch through the connection F5 for the second gas stream, which connection is present on an end side of an example of an electrically insulating element in FIG. 4 and is present at the bore I1, and through the duct which is formed with the bore I1 in the interior of the electrically insulating element 1. The bore F4 is formed at the other end-side end of the electrically insulating element 1. The annular groove is formed in a radially encircling manner on the outer lateral surface of the electrically insulating element 1 and communicates with the gas distributor 4, not illustrated here, so that the second gas stream cannot flow out through the gas distributor 4.

The gas distributor 4 can be fitted into the annular groove which is directly formed on the end face of the electrically insulating element 1 and is open in the direction of the workpiece surface to be processed.

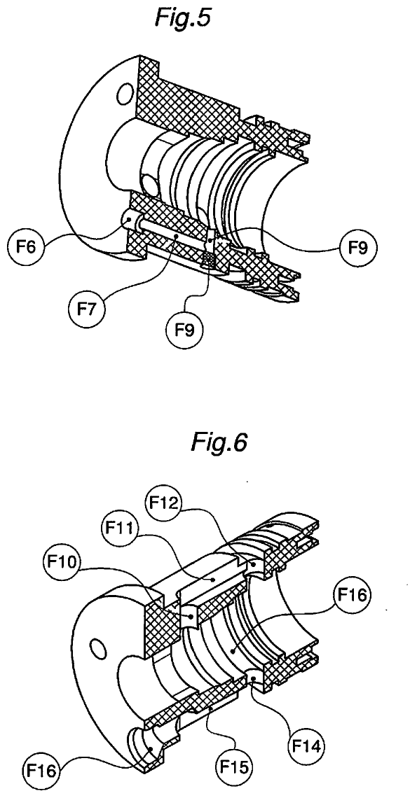

The illustration of FIG. 5 shows a gas connection F6 on the bore I2 through which the first gas stream can be introduced, by way of the duct F7, into the outer casing of the electrically insulating element 1. A further bore F8, into which the bore I2 issues, is formed perpendicular to said duct. The bore F8 extends through the entire casing of the electrically insulating element 1, so that the second gas stream can flow through the inner gas nozzle carrier 3, not shown here, to the inner gas nozzle 8. An internal thread F9, which serves for fastening a closure screw (not illustrated), is formed on the bore F8. The sectional illustration shown in FIG. 5 has been taken in a position rotated through a few degrees in relation to FIG. 4.

The sectional illustration of the electrically insulating element 1, which sectional illustration is shown in FIG. 6 and is rotated through a different angle in relation to FIGS. 4 and 5, shows possible ways of distributing cooling medium which is guided through the electrically insulating element 1.

The cooling medium passes through the bore F10 into the duct F11, which is formed parallel to the longitudinal axis of the TIG torch, and then through the bore F12 into an annular groove F13 and from there, via the bore F14, into the duct F15 which is oriented parallel to the longitudinal axis of the TIG torch. From said duct, said cooling medium exits the electrically insulating element 1 via the opening F16 and can be guided to a heat exchanger (not illustrated).

Therefore, it can be stated that a cooling medium can be guided both in circulation and also in countercurrent by an electrically insulating element.

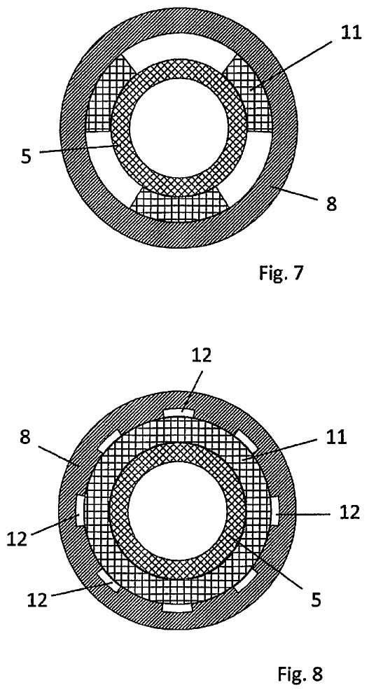

FIG. 7 shows an example of an electrically insulating element 1 which a further electrically insulating element 11, which is formed from a plurality of segments which are arranged at a distance from one another in this example, between an electrode holder 5 and the inner gas nozzle 8. The segments bear, by way of their inner lateral surface, against the outer lateral surface of the electrode holder 5 and, by way of their outer lateral surfaces, against the inner lateral surface of the inner gas nozzle 8.

This is also the case for the further electrically insulating elements 11 of one-piece design, as shown in FIGS. 8 to 11.

In the example according to FIG. 7, the ducts are formed between the segments, it being possible for the first gas stream to flow through said ducts in the direction of the respective workpiece surface. To this end, the segments should be formed at the same angular distances from one another in each case and oriented and/or dimensioned in the same way in each case in order to be able to maintain uniform flow conditions over the circumference of the electrode holder 5. There are three segments in this example. However, at least two or more than three segments can also be used.

FIG. 8 shows an example of a further electrically insulating element 11. In this case, ducts in the form of longitudinal grooves 12 which are formed parallel to the longitudinal axis of the TIG torch are formed in the inner lateral surface of the inner gas nozzle 8. The first gas stream can flow through the ducts 12 in the direction of the workpiece surface.

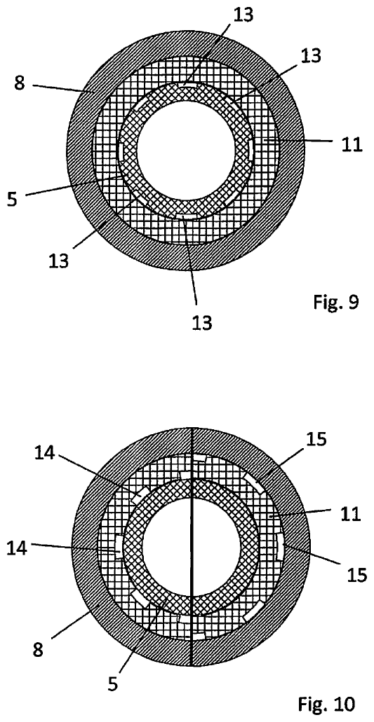

FIG. 9 shows an example in which ducts in the form of longitudinal grooves 13 are formed in the outer lateral surface of the electrode holder 5, it being possible for the first gas stream to flow through said ducts in the direction of the workpiece surface. The longitudinal grooves 13 are also formed parallel to the longitudinal axis of the TIG torch.

The example shown in FIG. 10 is intended to illustrate that longitudinal grooves 14 and 15 can also be formed on the inner lateral surface and/or the outer lateral surface of the further electrically insulating element 11 and can be used for guiding the first gas stream.

The longitudinal grooves 12, 13, 14 and 15 should likewise be geometrically configured and dimensioned in the same way and be arranged at the same angular distances from one another in each case and also be oriented parallel to one another and, as far as possible, also parallel to the central longitudinal axis of the TIG torch.

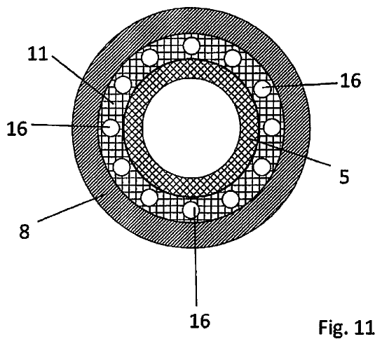

In the example shown in FIG. 11, ducts 16 are formed for guiding the first gas stream through the further electrically insulating element 11. The ducts 16 should also be geometrically configured and dimensioned in the same way and be arranged at the same angular distances from one another in each case and also be oriented parallel to one another and, as far as possible, also parallel to the central longitudinal axis of the TIG torch.

By way of a further electrically insulating element 11 which is designed and accordingly arranged in this way, it is advantageously possible to ensure that the inner gas nozzle 8 and the electrode holder 5 are oriented concentrically in relation to one another, so that a homogeneous first gas stream can exit from the TIG torch in the direction of the workpiece surface radially around the electrode holder 5.

Similarly to the further electrically insulating element 12, 13, 14 or 15, there can also be electrically insulating coatings between the inner gas nozzle 8 and the electrode holder 5. Said electrically insulating coating should preferably be formed on the outer lateral surface of the electrode holder 5.

In the in FIGS. 7 to 11, a further insulating element 12, 13, 14, 15 or an electrically insulating coating can also be arranged or be present on an electrode tube 10 alone or in addition to the electrode holder 5.

1. A TIG torch for welding, soldering or coating, in which an electrode is radially surrounded by an inner gas nozzle and a first gas stream is guided in the direction of a workpiece surface through at least one gap between the inner lateral surface of the inner gas nozzle and the outer lateral surface of the electrode and the inner gas nozzle is fastened to a sleeve-like inner gas nozzle carrier, and
the inner gas nozzle is surrounded in the radial direction by an outer gas nozzle which is fastened to an outer gas nozzle carrier or directly to an outer gas nozzle and a second gas stream is guided in the direction of the workpiece surface between the radially outer lateral surface of the inner gas nozzle and the inner lateral surface of the outer gas nozzle,
wherein
an electrically insulating element is arranged between the inner gas nozzle carrier, the inner gas nozzle and/or the electrode and the outer gas nozzle carrier and/or the outer gas nozzle.

2. The TIG torch as claimed in claim 1, wherein the inner gas nozzle is directly connected to the electrically insulating element.

3. The TIG torch as claimed in claim 1, wherein the electrically insulating element is of sleeve-like design and/or is connected in a rotationally fixed and rotationally symmetrical manner to the outer gas nozzle carrier, to the inner gas nozzle carrier and also to the electrode holder in a manner oriented with respect to the central longitudinal axis of the electrode which is formed with an electrode holder and an electrode tip.

4. The TIG torch as claimed in claim 1, wherein the inner gas nozzle is radially surrounded at least as far as the electrode tip which protrudes out of the TIG torch.

5. The TIG torch as claimed in claim 1, wherein grooves, ducts and/or bores for guiding the first gas stream, the second gas stream and/or a cooling medium are formed in the and/or on the sleeve-like electrically insulating element.

6. The TIG torch as claimed in in claim 5, wherein ducts or grooves which are oriented parallel to the longitudinal axis of the electrode and/or
grooves which are radially formed on the inner or outer lateral surface of the sleeve-like electrically insulating element are provided on the sleeve-like electrically insulating element for guiding one of the gas streams or the cooling medium.

7. The TIG torch as claimed in in claim 5, wherein a supply for cooling medium to the outer gas nozzle and/or the outer gas nozzle carrier is guided through the electrically insulating element.

8. The TIG torch as claimed in claim 1, wherein a measuring device for monitoring an electric current flow or the electrical voltage potential is arranged or connected between the electrode and the inner gas nozzle and/or the inner gas nozzle and the outer gas nozzle and is connected to an evaluation and/or switch-off unit for the arc on the TIG torch.

9. The TIG torch as claimed in claim 1, wherein a spline toothing is formed on the lateral surface of the inner gas nozzle carrier, which spline toothing is connected in an interlocking manner to the lateral surface of the electrically insulating element by being pressed in in a direction parallel to the longitudinal axis of the TIG torch.

10. The TIG torch as claimed in claim 1, wherein the electrode holder, the inner gas nozzle, the inner gas nozzle carrier, the outer gas nozzle, the electrically insulating element and/or the outer gas nozzle carrier are/is in each case formed from a plurality of individual elements which are connected to one another.

11. The TIG torch as claimed in claim 1, wherein a gas distributor which homogenizes the second gas stream in the form of a ring is arranged on the end side of the sleeve-like electrically insulating element, which end side faces in the direction of the workpiece surface.

12. The TIG torch as claimed in claim 11, wherein the gas distributor is designed in the form of a screen, as an open-pore sintered body, as an open-pore foam body, with bores which are arranged in a manner distributed at equal distances from one another and have a small free cross section, or in the form of a perforated metal sheet and is connected to a supply for the second gas stream through the sleeve-like electrically insulating element.

13. The TIG torch as claimed in claim 11, wherein the gas distributor is connected in a gas-tight manner, preferably by means of a press-fit connection, to the electrically insulating element on its outer lateral surfaces as far as the supply for the second gas stream.

14. The TIG torch as claimed in claim 1, wherein at least one further electrically insulating element is arranged in the gap between the outer lateral surface of the electrode holder and the inner lateral surface of the inner gas nozzle
or
an electrically insulating coating is formed on the outer lateral surface of the electrode holder and/or on the inner lateral surface of the inner gas nozzle in a locally defined manner, so that the first gas stream can flow in the direction of the workpiece surface and at the same time an electrical short circuit between the electrode holder and the inner gas nozzle is prevented and concentric orientation of the electrode holder and the inner gas nozzle can be achieved while maintaining a constant gap size between the outer lateral surface of the electrode holder and the inner lateral surface of the inner gas nozzle over the entire circumference.

15. The TIG torch as claimed in claim 14, wherein a further electrically insulating element is of sleeve-like design and a gap is formed between the inner gas nozzle, the inner gas nozzle carrier, the electrode tube and the electrode holder, the first gas stream flowing in the direction of the workpiece surface through said gap
or
a plurality of second electrically insulating elements which are arranged in a manner distributed at a distance from one another over the outer circumference of the electrode are provided
or
a plurality of electrically insulating coatings are formed at distances from one another on the outer lateral surface of the electrode and/or on the inner lateral surface of the inner gas nozzle in a manner distributed over the circumference.

16. The TIG torch as claimed in claim 1, wherein the electrically insulating element is fastened in a cohesive, interlocking and/or force-fitting manner in the form of a rotation-prevention means to the electrode, to an electrode tube or electrode holder which secures the electrode and/or to the outer gas nozzle carrier.

17. The TIG torch as claimed in claim 16, wherein the outer and/or the inner lateral surface of the electrically insulating element can be rotationally fixedly secured in a non-rotationally symmetrical manner as a key/slot connection, with a toothing or by means of an element which engages in an interlocking manner, in particular a screw or a pin.

18. The TIG torch as claimed in claim 1, wherein the electrically insulating element is formed from a ceramic, polymeric material, a polymer or ceramic fiber composite material or a metal-ceramic or metal-polymer composite material.

19. The TIG torch as claimed in claim 1, wherein the outer gas nozzle can be connected to the outer gas nozzle carrier and the inner gas nozzle can be connected to the inner gas nozzle carrier by means of screw connection.
